(19) United States
(12) Patent Application Publication
(10) Pub. No.: US 2025/0332042 A1
(43) Pub. Date: Oct. 30, 2025

(54) Mobility Vehicle

(71) Applicant: Avan Mobility INC., Winnipeg (CA)

(72) Inventor: Bryn Jones, Winnipeg (CA)

(21) Appl. No.: 19/081,256

(22) Filed: Mar. 17, 2025

Related U.S. Application Data
(60) Provisional application No. 63/638,125, filed on Apr. 24, 2024.

(51) Int. Cl. A61G 3/08; A61G 3/06; B62D 65/02

(52) U.S. Cl. CPC A61G 3/0808; B62D 65/024; A61G 3/061

(57) ABSTRACT

The method uses a vehicle having a cargo area having a floor and a hatch having a component. When closed, the hatch occludes the area, the component engages the body and the floor extends to a position overlying the rear axle. The open hatch provides egress to the area. The method comprises: removing that portion of the body that lies above a notional ramp that extends from ground to the position, that portion including the component; removing that portion of the frame that lies above the notional ramp. A pan is mounted to the body to define a wheelchair receiver in the area congruent with the notional ramp. An extender is pivotably mounted to the rearward pan end for movement between: a lowered position, whereat it defines a wheelchair ramp congruent with the notional ramp and extending to the receiver; and a raised position, whereat it lies within the area.

### FIELD

The invention relates to the field of mobility vehicles.

### BACKGROUND

It is well known to mount a ramp to a vehicle to facilitate the transport of wheelchairs and their users. Known vehicles of this type often suffer from relatively high cost.

### SUMMARY

Forming one aspect of the invention is a method for use with a body on frame vehicle, the vehicle being of the type having a hatch at the rear of the vehicle, the hatch having a closed position that occludes a cargo area of the vehicle and an open position that provides egress to the cargo area, the cargo area having a substantially horizontal cargo floor that extends, when the hatch is in the closed position, from the hatch to a position overlying the rear axle, the hatch having a component that, when in the closed position, engages a mating component on the body to maintain the hatch in the closed position.

The method comprises:
removing from the vehicle: that portion of the body that lies above a notional wheelchair ramp that extends from the ground to the position overlying the rear axle, that portion including the mating component; and that portion of the frame that lies above the notional wheelchair ramp;
mounting a pan to the body to define a wheelchair receiver that lies in the cargo area and is congruent with the notional wheelchair ramp;
pivotably mounting, to the rearward end of the pan, an extender that is movable between: a lowered position, whereat it defines a wheelchair ramp that is congruent with the notional wheelchair ramp and extends to the wheelchair receiver; and a raised position, whereat it lies within the cargo area.

According to another aspect, the method can comprise: reinforcing the frame with a U-shaped support that is spaced-apart from the pan sufficient to avoid interference in normal driving conditions.

According to another aspect, the extender can have a component that, when the extended is in the raised position and the hatch is in the closed position, functions in the manner of the mating component.

According to another aspect, the wheelchair receiver can be shaped and dimensioned to receive a wheelchair and a seated user of the wheelchair, and the wheelchair extender is shaped and dimensioned to permit the wheelchair and a seated user of the wheelchair to be wheeled to the wheelchair receiver when the hatch is in the open position and the extended is in the lowered position.

Advantages, features and characteristics will become apparent upon review of the following detailed description, with reference to the accompanying drawings, the latter being briefly described hereinafter.

### BRIEF DESCRIPTION OF THE DRAWINGS

FIG. 1 is a view of a prior art body on frame vehicle with hatch closed;

FIG. 2 is a view of the vehicle of FIG. 1 with hatch open;

FIG. 3 is a view of the structure of FIG. 2 with a notional wheelchair ramp shown in dotted line;

FIG. 4 is an exploded view of the structure of FIG. 2

FIG. 5 is the structure of encircled area 5 of FIG. 4 with a portion removed and the notional ramp shown;

FIG. 6 is the structure of encircled area 6 of FIG. 4 with a portion removed and the notional ramp shown;

FIG. 7 is the structure of FIG. 5 and a pan positioned for installation

FIG. 8 is the structure of FIG. 7 with the pan installed

FIG. 9 is the structure of FIG. 6 with a brace positioned for installation

FIG. 10 is the structure of FIG. 8 with the brace installed

FIG. 11 is the structure of FIG. 8 installed on the structure of FIG. 10

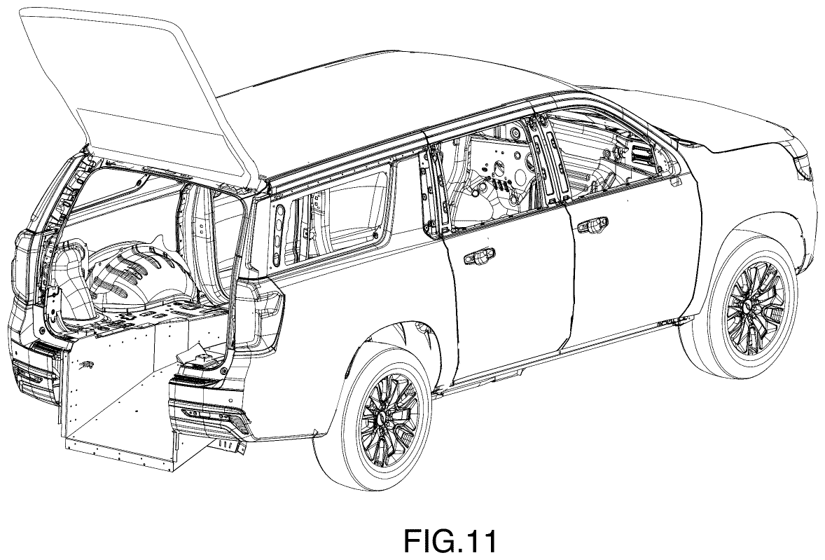

FIG. 12 is the structure of FIG. 11 with a ramp installed and in the lowered position

FIG. 13 is the structure of FIG. 11 with the ramp in a raised position

FIG. 14 is the structure of FIG. 13 with the hatch closed

FIG. 15 is a cross section of the structure of FIG. 14

FIG. 16 is view of the structure of FIG. 14 from a different vantage point

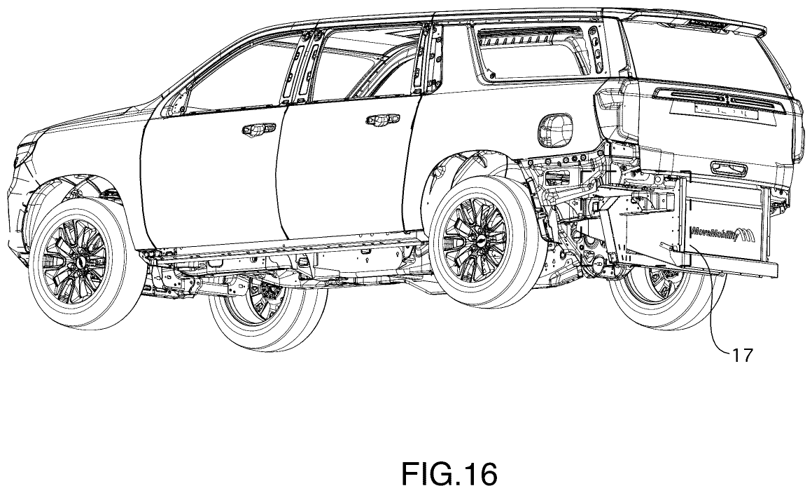

FIG. 17 is an enlarged view of encircled area 17 of FIG. 16

FIG. 18 is a view of the structure of FIG. 14 with the body and portions of the frame removed for clarity

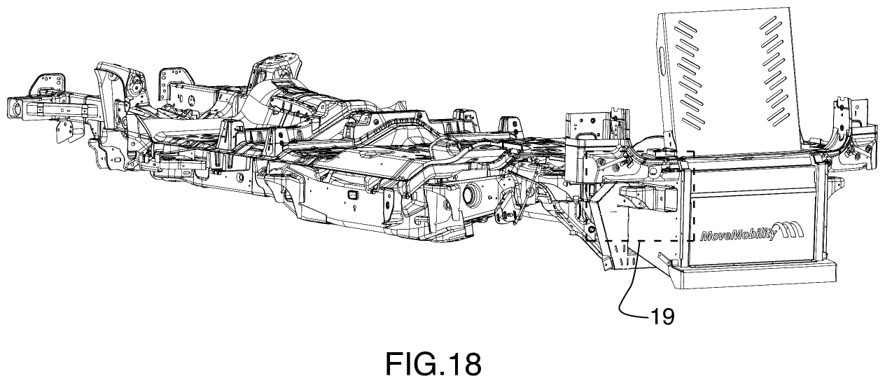

FIG. 19 is an enlarged view of encircled area 19 of FIG. 18

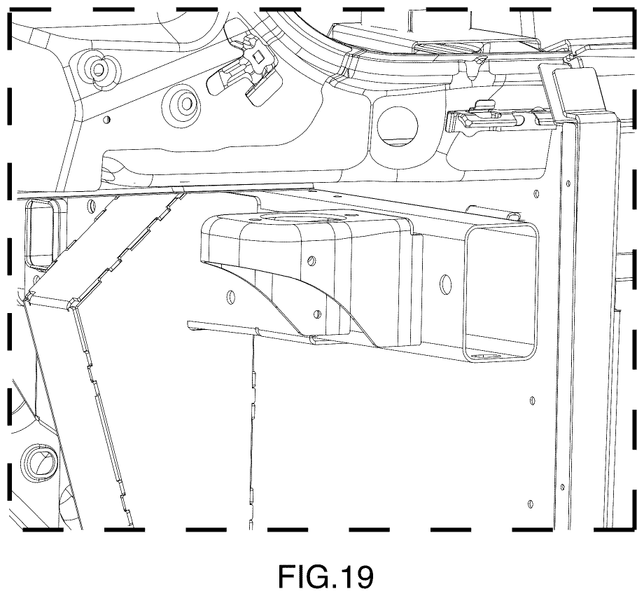

FIG. 20 is a view similar to FIG. 15 with a wheelchair secured in the receiver

FIG. 21 is a view similar to FIG. 15 showing the route of a wheelchair into the receiver

FIG. 22 is a view of a portion of the vehicle

FIG. 23 is a view of a portion of the vehicle

### DETAILED DESCRIPTION OF AN EXAMPLE OF THE METHOD

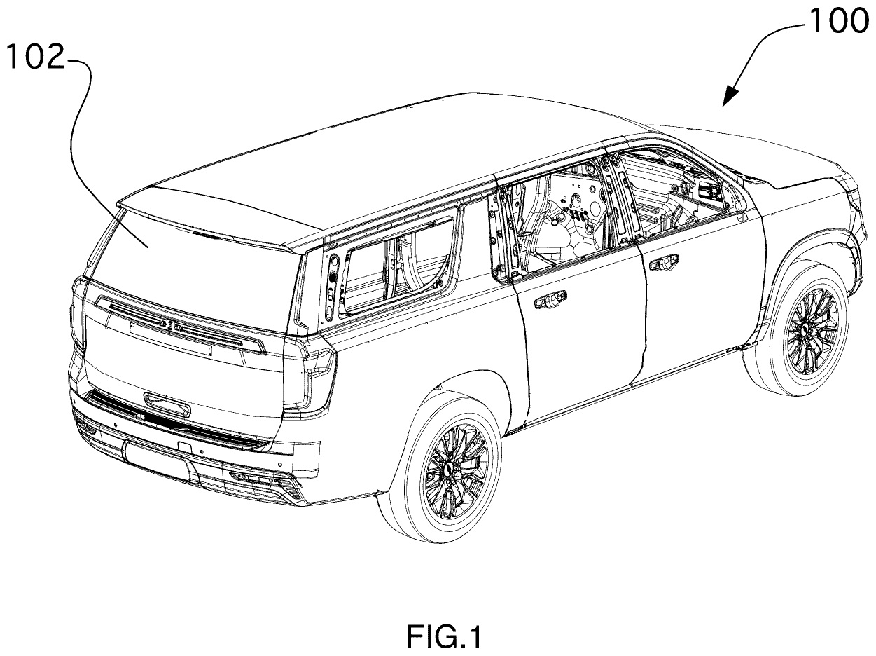

As an initial matter, the example method will be understood to be for use with a Chevrolet Suburban 100, an example being shown in FIG. 1.

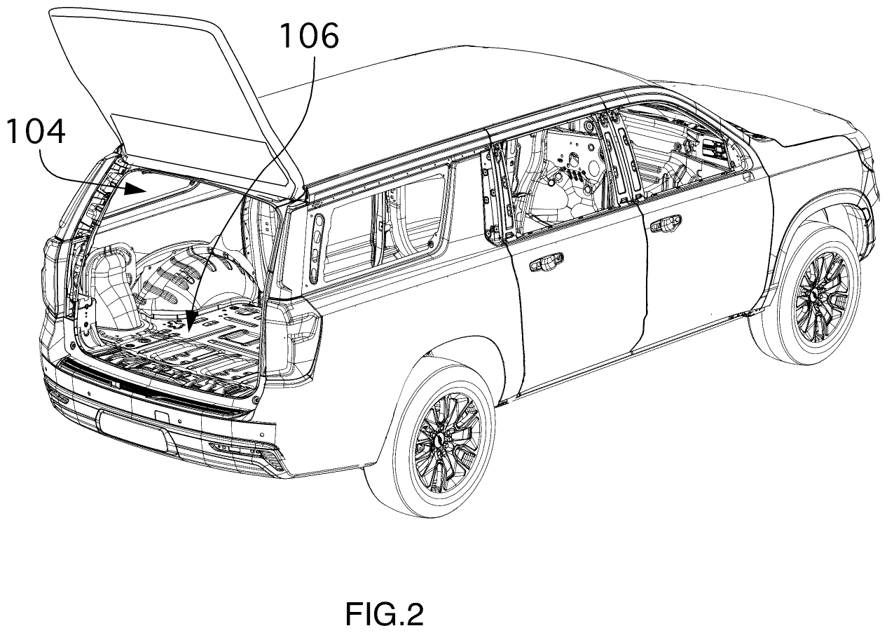

This vehicle is of the type having a hatch 102 at the rear of the vehicle, the hatch having a closed position as shown in FIG. 1 that occludes a cargo area 104 of the vehicle and an open position as shown in FIG. 2 that provides egress to the cargo area. As seen in FIG. 2, the cargo area has a substantially horizontal cargo floor 106 that extends, when the hatch is in the closed position, from the hatch to a position frontwardly of the rear axle. The hatch will be understood to have a component, not shown, that, when in the closed position, engages a mating component on the body to maintain the hatch in the closed position.

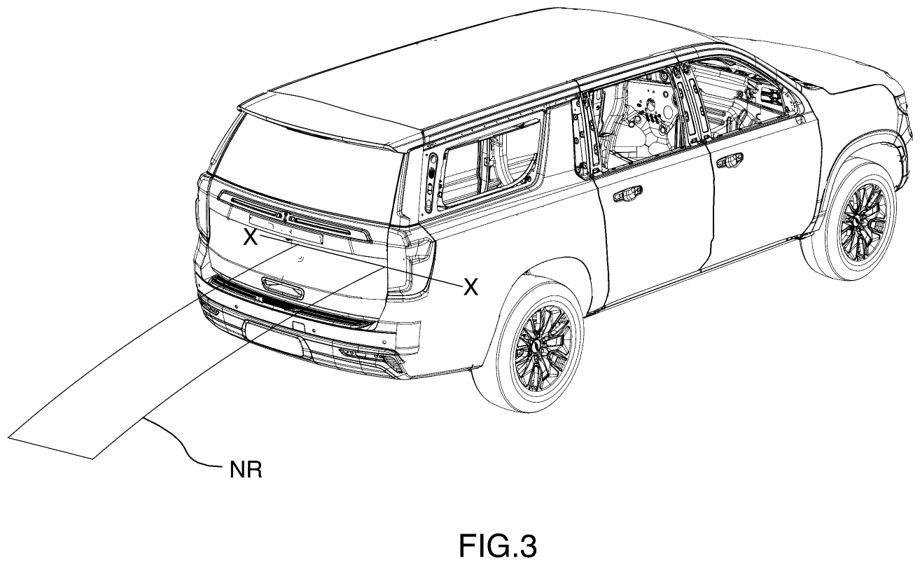

The example method comprises a removing step, a pan mounting step, a reinforcement step and an extender mounting step, and should be understood to be defined by a notional wheelchair ramp NR that extends from the ground to a position X-X overlying the rear axle, as shown in dotted outline in FIG. 3.

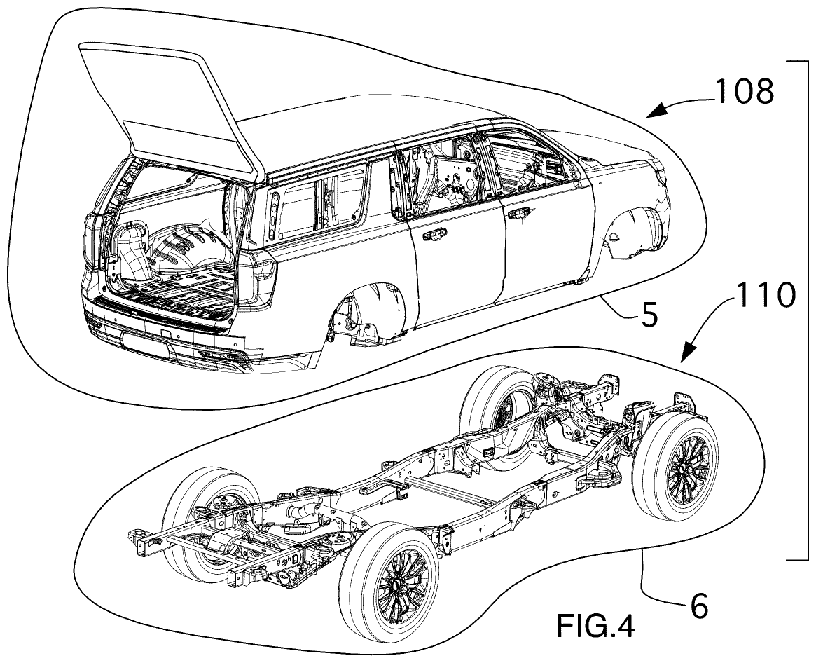

FIG. 4 shows the body 108 and the frame 110 of the vehicle. This is for illustration, only; removal of the body from the frame forms not part of the example method.

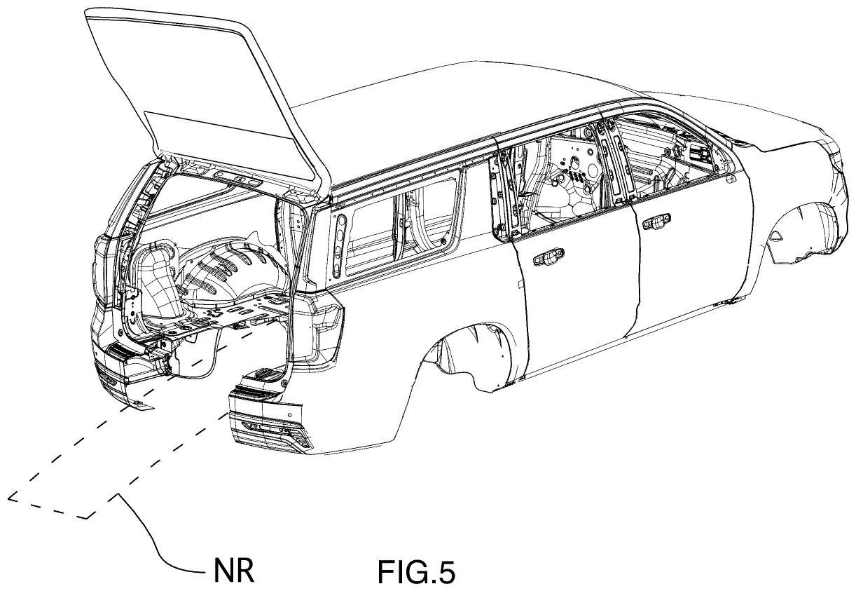

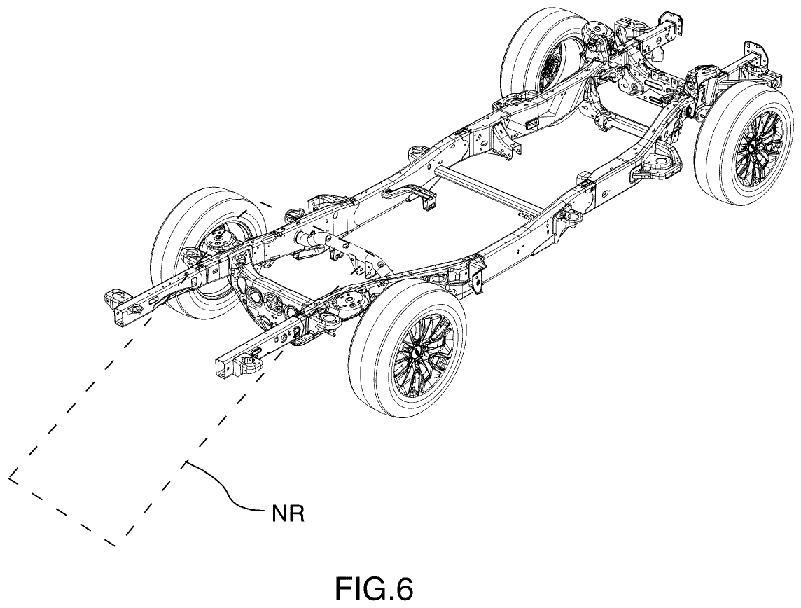

In the removing step, the following is removed from the vehicle
that portion of the body [FIG. 5] that lies above the notional wheelchair ramp, that portion including the mating component; and
that portion of the frame [FIG. 6] that lies above the notional wheelchair ramp.

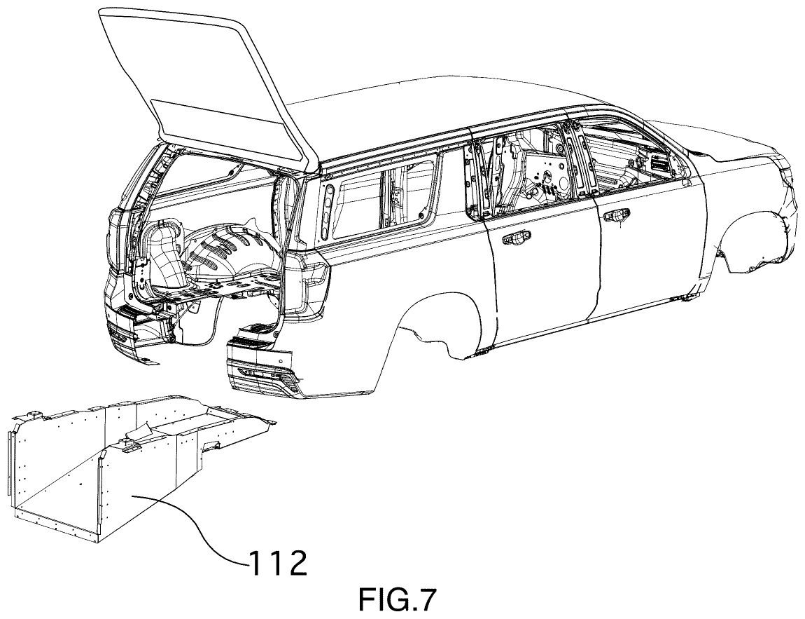

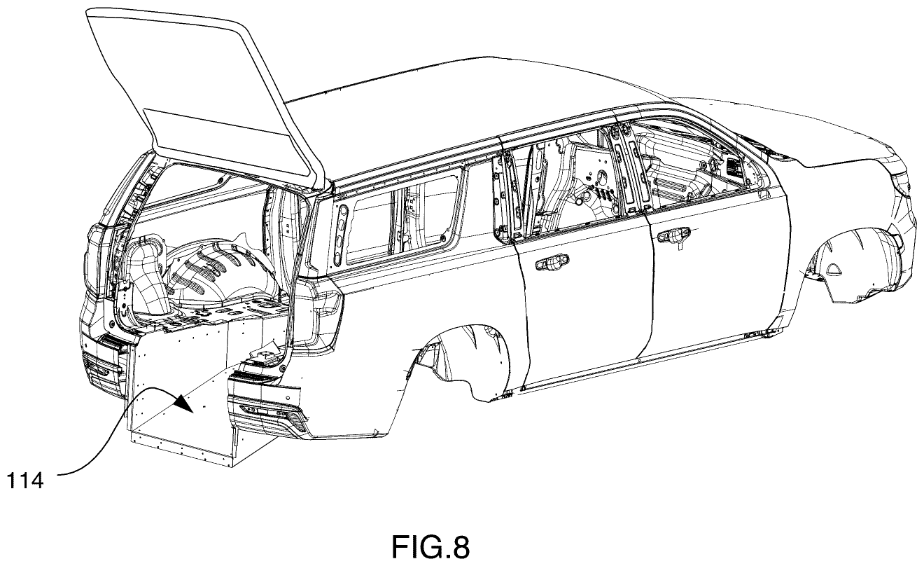

In the pan mounting step, indicated by the sequence of FIGS. 7, 8, a pan 112 is mounted to the body to define a wheelchair receiver 114 that lies in the cargo area and is congruent with the notional wheelchair ramp.

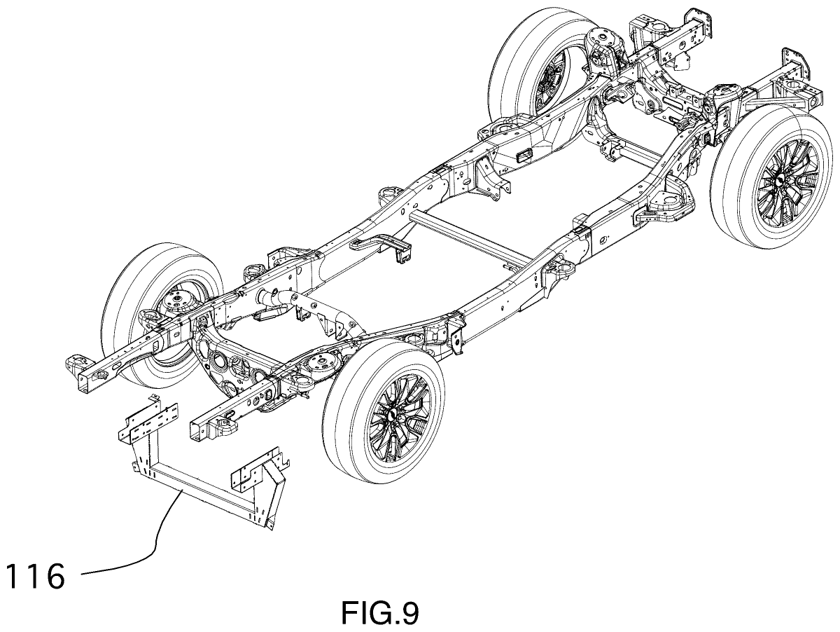

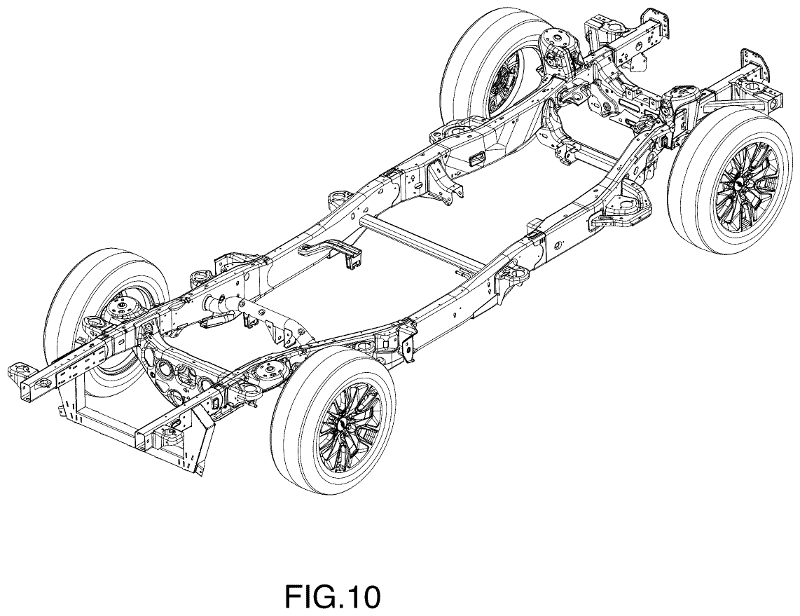

In the reinforcement step, indicated by the sequence of FIGS. 9, 10 the frame is reinforced with a U-shaped support 116 that is spaced-apart from the pan sufficient to avoid interference in normal driving conditions.

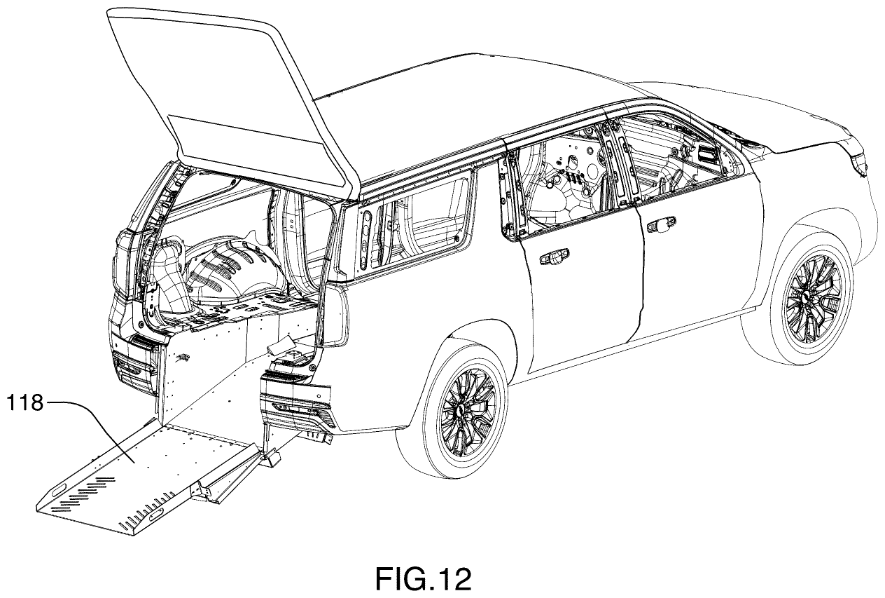

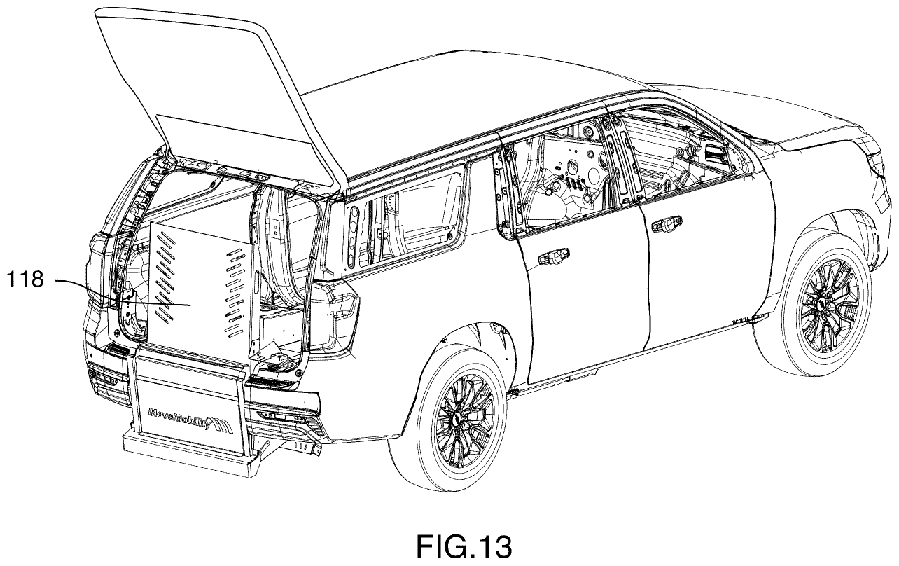

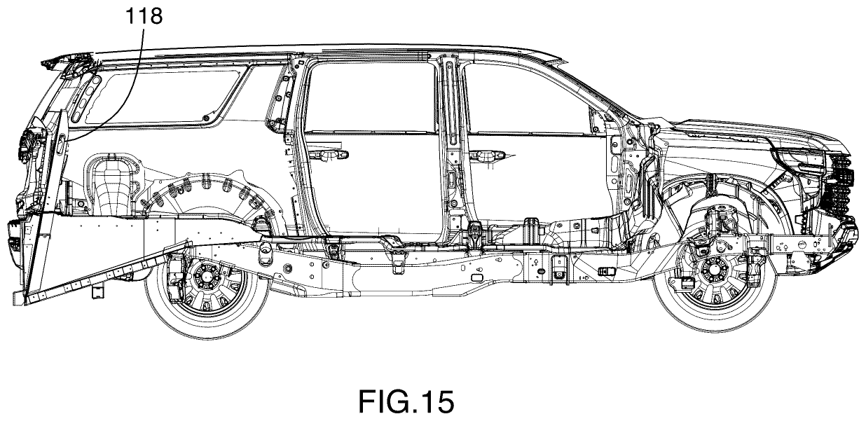

In the extender mounting step, to the rearward end of the pan, an extender 118 is pivotably mounted for movement between
a lowered position [shown in FIG. 12], whereat it defines a wheelchair ramp 120 that is congruent with the notional wheelchair ramp and extends to the wheelchair receiver; and
a raised position [shown in FIG. 13 and FIG. 15], whereat it lies within the cargo area.

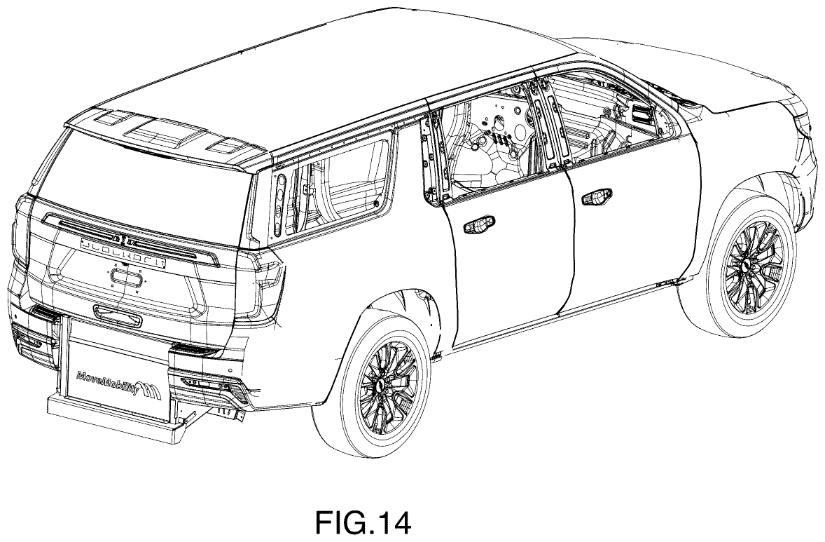

The extender has a component that, when the extended is in the raised position and the hatch is in the closed position, functions in the manner of the mating component, as indicated in FIG. 14.

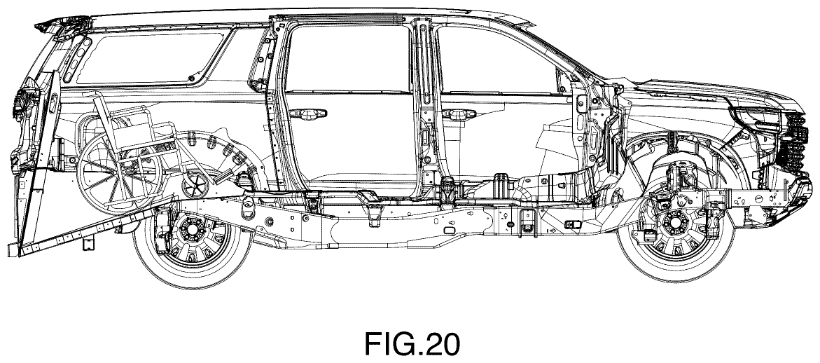

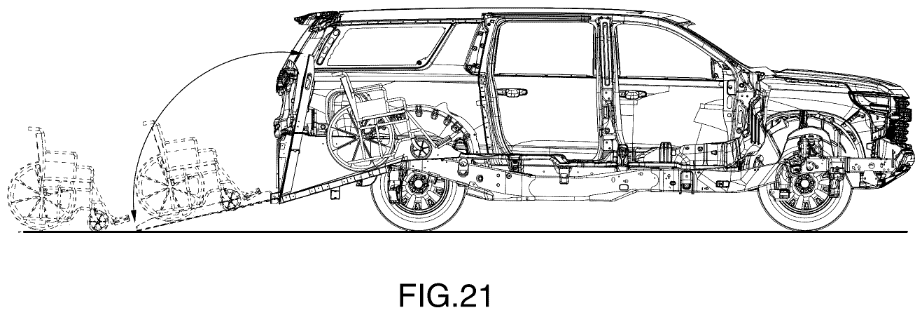

As indicated in FIG. 20, the wheelchair receiver is shaped and dimensioned to receive a wheelchair and a seated user of the wheelchair, and, as indicated in FIG. 21, the wheelchair extender is shaped and dimensioned to permit the wheelchair and a seated user of the wheelchair to be wheeled to the wheelchair receiver when the hatch is in the open position and the extended is in the lowered position.

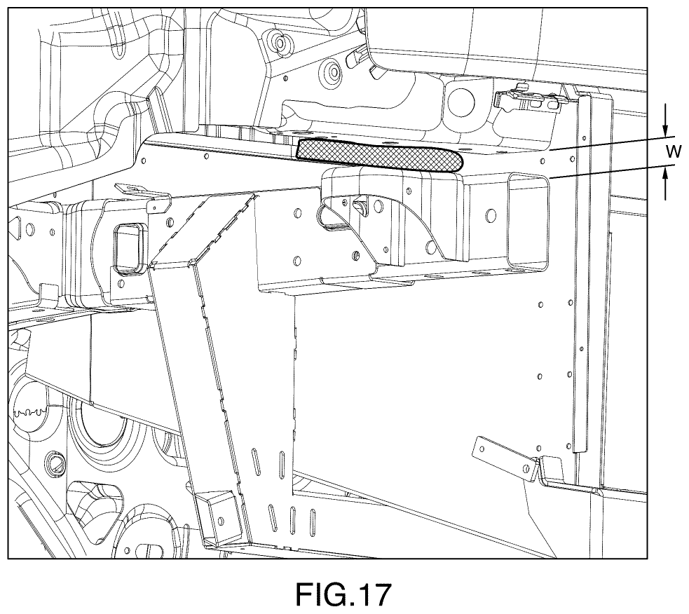

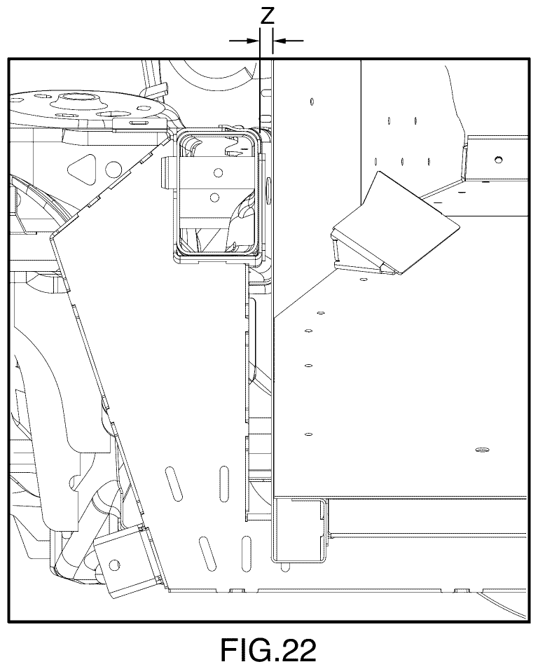

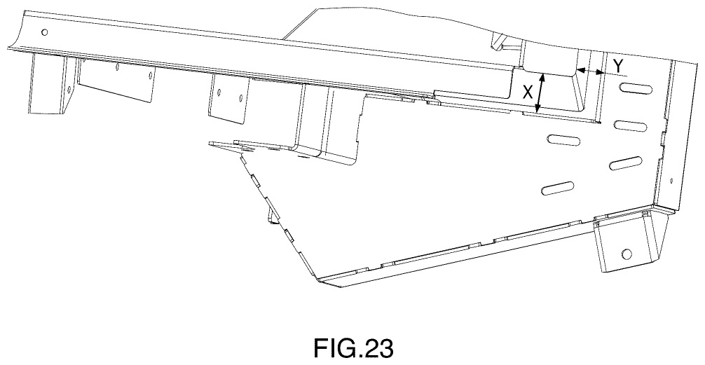

Precise dimensioning was required to achieve enough space in the vehicle to provide for the receipt of a wheelchair and user within the cargo area of a sports utility vehicle without altering the roofline or prejudicing road clearance is lowering the body and frame. Some critical dimensions in the finished product are shown in drawings, namely:

| | | | |
|---|---|---|---|
| FIG. 17 | | W | 1.33671” |
| FIG. 22 | | Z | .22079” |
| FIG. 23 | | X | .8281” |
| | 1. | Y | .5884” |

Whereas a specific embodiment is described, variations are of course possible. Accordingly, the invention should be understood to be limited only by the accompanying claims, purposively construed.

1. A method for use with a body on frame vehicle, the vehicle being of the type having a hatch at the rear of the vehicle, the hatch having a closed position that occludes a cargo area of the vehicle and an open position that provides egress to the cargo area, the cargo area having a substantially horizontal cargo floor that extends, when the hatch is in the closed position, from the hatch to a position overlying the rear axle, the hatch having a component that, when in the closed position, engages a mating component on the body to maintain the hatch in the closed position, the method comprising:
removing from the vehicle
that portion of the body that lies above a notional wheelchair ramp that extends from the ground to the position overlying the rear axle, that portion including the mating component; and
that portion of the frame that lies above the notional wheelchair ramp;
mounting a pan to the body to define a wheelchair receiver that lies in the cargo area and is congruent with the notional wheelchair ramp;
pivotably mounting, to the rearward end of the pan, an extender that is movable between
a lowered position, whereat it defines a wheelchair ramp that is congruent with the notional wheelchair ramp and extends to the wheelchair receiver; and
a raised position, whereat it lies within the cargo area.

2. A method according to claim 1, further comprising:
reinforcing the frame with a U-shaped support that is spaced-apart from the pan sufficient to avoid interference in normal driving conditions.

3. A method according to claim 1, wherein the extender has a component that, when the extended is in the raised position and the hatch is in the closed position, functions in the manner of the mating component.

4. A method according to claim 1, wherein the wheelchair receiver is shaped and dimensioned to receive a wheelchair and a seated user of the wheelchair, and the wheelchair extender is shaped and dimensioned to permit the wheelchair and a seated user of the wheelchair to be wheeled to the wheelchair receiver when the hatch is in the open position and the extended is in the lowered position.
